(19) United States
(12) Patent Application Publication
(10) Pub. No.: US 2026/0217410 A1
(43) Pub. Date: Jul. 30, 2026

(54) A BLANK AND A PACKAGE

(71) Applicant: Stora Enso OYJ, Helsinki (FI)

(72) Inventors: Vesa Penttinen, Hatsola (FI); Mika Tuhkunen, Lahti (FI)

(73) Assignee: Stora Enso OYJ, Helsinki (FI)

(21) Appl. No.: 19/159,019

(22) PCT Filed: Feb. 23, 2024
(86) PCT No.: PCT/IB2024/051758

§ 371 Date: Aug. 22, 2025

(30) Foreign Application Priority Data
Feb. 24, 2023 (SE) 2350211-5

(51) Int. Cl. B65D 5/28; B31B 50/26; B65D 5/42

(52) U.S. Cl. CPC B65D 5/28; B31B 50/26; B65D 5/42

(57) ABSTRACT

A blank forming a double-walled box, comprising: a rectangular inner bottom panel a first and a second inner end wall panel foldably connected to a respective one of two opposing transversally extending sides of the inner bottom panel, a first and a second inner side wall panel foldably connected to a respective one of two opposing longitudinally extending sides of the inner bottom panel, a rectangular outer bottom panel which is larger in size than said inner bottom panel (100), a first and a second outer end wall panel foldably connected to a respective one of two opposing transversally extending sides of the outer bottom panel, a first outer side wall panel comprising two opposing longitudinally extending sides, of which a first side is foldably connected to said first inner side wall panel and a second side is foldably connected to said outer bottom panel, a second outer side wall panel foldably connected to a longitudinally extending side of said second inner side wall panel, wherein the inner bottom panel, the first and second inner side wall panels and the first and second inner end wall panels define a box interior when formed into a box, and wherein the outer bottom panel, the first and second outer side wall panels, and the first and second outer end wall panels are configured to form an outer layer of said box when formed into a box, such that each side of the box comprises double walls. The present invention also relates to a box formed by folding a blank according to the invention.

### TECHNICAL FIELD

The invention relates to a blank for forming a leakproof and thermally insulated box. The invention also relates to a box. Such a package may e.g. be used to carry wet products, such as wet food products, such as meat, vegetables or fish.

### BACKGROUND

When designing a package or a box for transport of products, it is desirous to take into account a number of different design criteria. The package should e.g. make efficient use of the material, be easy to transport to the point of use, be easy to prepare for use, and it should provide a strong package. The package should be capable of protecting the goods transported in the package, and it should be strong during handling. When designing a package for transport of wet food products, such as meat, vegetables or fish, it is often a difficulty to make it capable of remaining mechanically stable over a sufficient time period. Packages formed of cardboard or paper-based materials often lose the mechanical stability due to moisture soaking into the material whereby the cardboard or paper-based material becomes softer than they are in dry condition. Another challenge associated with the transport of food stuff such as fish and/or vegetables is temperature control safeguarding that the goods are not spoiled e.g. due to temperatures outside the allowed threshold.

An example of a package formed by folding a blank is disclosed in GB1424712A. The document discloses a blank which is coated with moisture impervious material and which is formed into a carton by folding the corner gussets against the outer faces of the side walls, folding the side wall flaps over the gussets and then folding the front flap inwards to overlie the base panel. Each end of the flap is connected to the adjacent corner gusset by a fillet which interlocks with the adjacent end of a side flap. A notch in each flap provides an edge against which the fillet abuts.

Another example of a package formed by folding a blank is disclosed in EP0455610A1. This document refers to a leakproof container for ice-cream or any other product, in various capacities, made in paperboard eventually treated on one side to be resistant to the penetration of water, oil or grease, depending upon the type of products contained in it. The container is made of a single paperboard blank cut and folded into a container body and a dependant hinged lid. The sides of the container body are interconnected by gusset folds in order to make them leakproof. The lid is provided with three side flaps which are glued to the corresponding side panels of the container body and are severable therefrom along pre-cut tearing strips to gain access to the contents. After the first opening, the container can be reclosed using a tong insertable into a slit.

There is still a need to provide an improved package which, from a manufacturing and a user perspective, addresses one or more of the design criteria of making efficient use of material, being possible to transport as flat-laid blanks, being easy to fold to form the corresponding box, and being capable of forming a package being stable. Moreover, there is a need to provide a package for wet content that is leakproof and remains mechanically stable over a sufficient time period. Moreover, there is a need to provide a reliable way to transport temperature-sensitive goods.

### SUMMARY OF THE INVENTION

It is an object of the invention to provide a blank and a box addressing at least some of the design criteria that the blank and box should make efficient use of the material, be easy to transport to the point of use, be easy to prepare for use, protect content from harmful thermal fluctuations during transportation, and it should provide a strong package capable of protecting the goods carried inside the box. Preferably, it remains mechanically stable over a sufficient time period, especially it is desirous that the package is stable also when containing wet products, such as wet food products, such as meat, vegetables or fish. Furthermore, the box should be recyclable and biodegradable.

These objects have in accordance with a first aspect been achieved by a cartonboard blank configured to be formed into a double-walled box or package arranged to be thermally insulated.

According to the invention, said blank comprises:
a rectangular inner bottom panel,
a first inner end wall panel and a second inner end wall panel being foldably connected to a respective one of two opposing transversally extending sides of the inner bottom panel,
a first inner side wall panel and a second inner side wall panel being foldably connected to a respective one of two opposing longitudinally extending sides of the inner bottom panel,
an outer bottom panel which is larger in size than said inner bottom panel, a first outer end wall panel and a second outer end wall panel being foldably connected to a respective one of two opposing transversally extending sides of the outer bottom panel,
a first outer side wall panel comprising two opposing longitudinally extending sides, where a first longitudinally extending side is foldably connected to said first inner side wall panel and a second longitudinally extending side is foldably connected to said outer bottom panel,
a second outer side wall panel being foldably connected to a longitudinally extending side of said second inner side wall panel,
wherein the inner bottom panel, the first and second inner side wall panels and the first and second inner end wall panels define a box interior when the blank is formed into a box, and
wherein the outer bottom panel, the first and second outer side wall panels, and the first and second outer end wall panels are configured to form an outer layer of said box when the blank is formed into a box, such that each side of the box comprises double walls.

According to one aspect of the invention, each of said double walls formed at each side of the box folded from said blank defines an inner cavity arranged to receive an insulating layer such as an insulating panel member. With a blank of the kind disclosed above, it is possible to provide a single blank being configured to be easily formed into a leakproof box arranged to be thermally insulated e.g. by means of placing insulating panel members in said inner cavities. Thanks to the invention, a box is provided which has good insulating properties, protecting content from temperature changes during transport. Also, the double-walled walls provide a leakproof, strong package which protects the content. Moreover, such a design is beneficious in view of protecting packages from losing their mechanical stability due to moisture soaking into the material.

By “longitudinally” is hereby meant having an extension at least substantially along a longitudinal extension of the box. By a “transversally” is hereby meant having an extension at least substantially along a transversal extension of the box.

At each corner of the inner bottom panel, the respective inner side wall panels may be interconnected with the inner end wall panels by a respective set of corner panels together forming a corner section, the corner panels being foldable relative to the respective inner side wall panel, to the respective inner end wall panel, and to each other about an internal fold line into triangular flaps, as the blank is formed into said box. This is a convenient manner of making it possible to provide a package having closed corners. This may be especially useful in combination with a polymer-coating on the surface intended to form an inside of the package. Such a package may e.g. be useful to transport moist food products, such as fish, meat, etc.

Upon folding the blank into a box, the triangular flaps may be configured to be folded outwardly, in a direction away from the middle of the box, and then preferably into abutment with an outwardly facing surface of a respective inner end wall panel. This is a convenient manner of making it possible to provide a package having tight and protected corners, such that the corners are not affected by moisture from the content in the package. Such a design is beneficious in view of protecting packages from losing their mechanical stability otherwise typically occurring due to moisture soaking into the material. The content is prevented from being soaked into the corner panels as the corner panels are placed at outside of the package. Such formed corners are, thus, beneficial as they contribute to robustness of the package by remaining unaffected by the content. This may be especially useful in combination with a polymer-coating on the major surface intended to form an inside of the package. Further, as the abutment between the corner panels and the side wall panel is positioned on the outside of the package, it does not come in contact with the content of the package. Moreover, abutting the triangular flaps to the outside surface of the inner side wall panels of the package, increases the overall stability of the package. The double-walled side walls, comprising the inner and the outer side wall panels, increase in stability due to the fact that it also includes the triangular flaps, since the overall thickness of the double-walled side walls increases. Thus, this contributes to making the package capable of carrying load on top of the package, which e.g. occurs when packages are stacked on top of each other.

The blank may further comprise gluing flaps being foldably connected to a respective one of two opposing transversally extending short sides of said outer side wall panels, wherein the gluing flaps are configured to be adhesively connected to an outer layer of said respective outer end wall panels as the blank is formed into said box. Such an adhesive connection is beneficial due to making efficient use of the material, as no extra locking mechanisms are needed. Moreover, such an adhesive connection makes the package easy to prepare for use. Further, by adhesive connection of the outer side wall panels to the outer end wall panels, a strong package is provided.

The blank may further comprise a set of transversally extending gluing panels being foldably connected to the respective opposite transversally extending short sides of said inner end wall panels, wherein the transversally extending gluing panels are configured to be adhesively connected to an outer layer of said respective gluing flaps as the blank is formed into said box. The blank may further comprise a longitudinally extending gluing panel being foldably connected to a longitudinal side of said second outer side wall panel, wherein the longitudinally extending gluing panel is configured to be adhesively connected to said outer bottom panel as the blank is formed into said box.

The attachment of the above-described gluing flaps and gluing panels may be provided by adhesive, such as hot-melt glue. Further, it may be provided by use of an adhesive tape. The adhesive tape may be an adhesive double-sided tape. The attachment may be provided by an adhesive strip.

The adhesive strip may be pre-attached during manufacturing process. Such pre-attached adhesive strip is preferably adhesively double-sided strip with the exposed surface being covered by a non-adhesive strip, such as paper strip. The adhesive strip may be an unmounted strip. The unmounted strip may, for example, be sold/provided separately and/or be attached as a separate unit when sold/provided.

The blank may further comprise transversal extension panels arranged between said respective inner end wall panel and said respective gluing panel. The blank may also comprise longitudinal extension panels arranged between said respective inner side wall panel and said respective outer side wall panel. The transversal-and longitudinal extension panels are configured to form upper surfaces of the erected double-walled box. Providing such top panels contributes to making the package capable of carrying other packages such that they may be stacked on top of each other.

In a preferred embodiment of the invention, the longitudinal sides of the inner side wall panels are shorter than the longitudinal sides of the outer side wall panels. As will be better understood from the detailed description, this feature leads to that the inner cavity arranged to receive an insulating layer can be created. One way of achieving this difference in length of the longitudinal sides is that the outermost distal short-sides of each longitudinal extension panel are arranged with oblique edges. These oblique edges extend obliquely from the corner sections of the respective inner side wall panel to a meeting corner section of the respective outer side wall panel. As a result, the longitudinal sides of the inner side wall panels are shorter than the longitudinal sides of the outer side wall panels.

The blank may be formed of a paper-based material such as a corrugated paperboard material. Such a material is typically light-weight. It is also typically easy to cut into the desired blank configuration and easily foldable and thereby easy to erect into a package. A paper-based material is often possible to recycle which makes it possible to provide an environmentally friendly package. Moreover, paper-based material belongs to a comparably inexpensive group of materials.

The blank may comprise a moisture and water-resistant coating or treatment to provide water resistance for packaging and transporting in wet or damp environment. For example, the blank may be provided with a leakproof inner lining such as a polymer-based layer on a first major surface of the blank, the first major surface being intended to form an inside of the package when the blank is erected into the package. Such a package may e.g. be useful to transport moist food products, such as fish, meat, etc.

According to a second aspect, the above object has also been achieved by a box obtained by forming or folding a blank as described above into a double-walled box or package. The box obtained by erecting a blank according to the invention may comprise at least one thermally insulating layer inside at least one of said inner cavities. The box may be provided with a top lid, such as a lift-off lid, said lid preferably comprising an insulating layer for protecting and insulating content of the box.

Said insulating layer is preferably made from recyclable material including cellulose-based material. Preferably, said insulating layer is capable of being recycled or is substantially biodegradable or compostable or any combination thereof. The insulating layer can be in the form of panels made from cardboard or paper. The insulating layer can also be in the form of panels made from foamed cellulose material. Thanks to insulating panels made from fiber-based material, the thermally insulated box according to the present invention is recyclable and to a large degree also biodegradable.

A further scope of applicability of the present invention will become apparent from the detailed description given below. However, it should be understood that the detailed description and specific examples, while indicating preferred embodiments of the invention, are given by way of illustration only, since various changes and modifications within the scope of the invention will become apparent to those skilled in the art from this detailed description. Hence, it is to be understood that this invention is not limited to the particular component parts of the device described or acts of the methods described as such device and method may vary. It is also to be understood that the terminology used herein is for purpose of describing particular embodiments and is not intended to be limiting.

It must be noted that, as used in the specification and the appended claims, the articles “a,” “an,” “the,” and “said” are intended to mean that there are one or more of the elements unless the context clearly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTION OF THE DRAWINGS

The above and other aspects of the present invention will, in the following, be described in more detail with reference to appended figures. The figures should not be considered limiting; instead they should be considered for explaining and understanding purposes. As illustrated in the figures, the sizes of layers and regions may be exaggerated for illustrative purposes and, thus, are provided to illustrate the general structures. Like reference numerals refer to like elements throughout. The invention will by way of example be described in more detail with reference to the appended schematic drawings, which shows a presently preferred embodiment of the invention.

FIG. 1a discloses a blank configured to be formed into a box.

FIG. 1b is a detailed view according to 1b in FIG. 1a.

FIG. 2 discloses an insulating layer assembly according to one example of the present invention.

FIGS. 3a-3h disclose different stages of how the blank of FIG. 1 is folded into a box.

FIG. 4 discloses a box according to the invention.

FIG. 5 discloses a lid for a box according to the invention.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and to fully convey the scope of the invention to the skilled person.

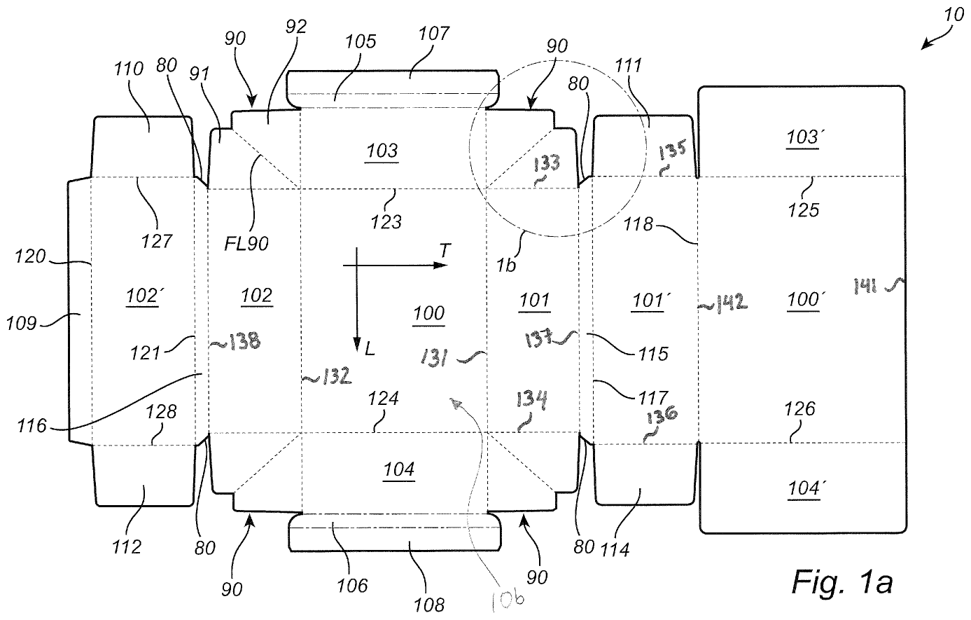

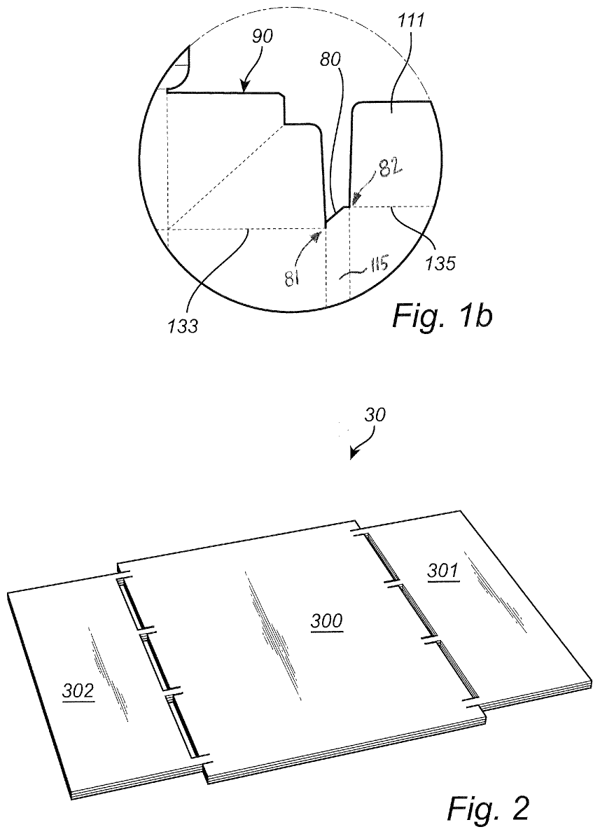

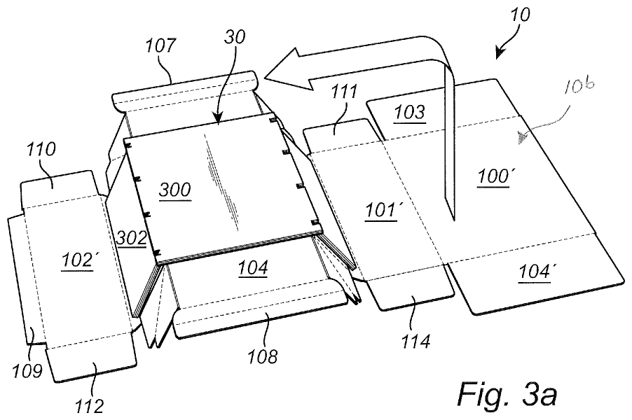

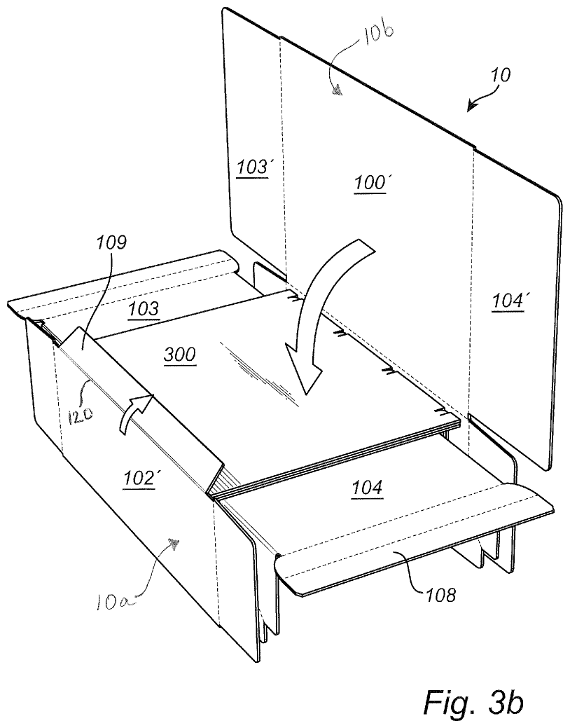

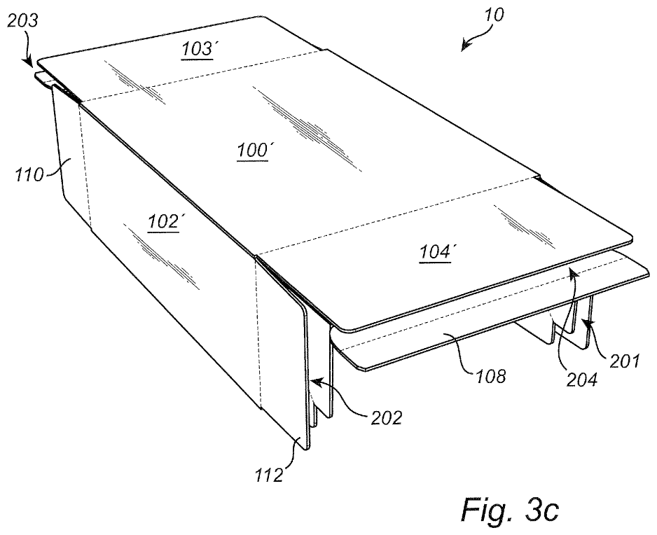

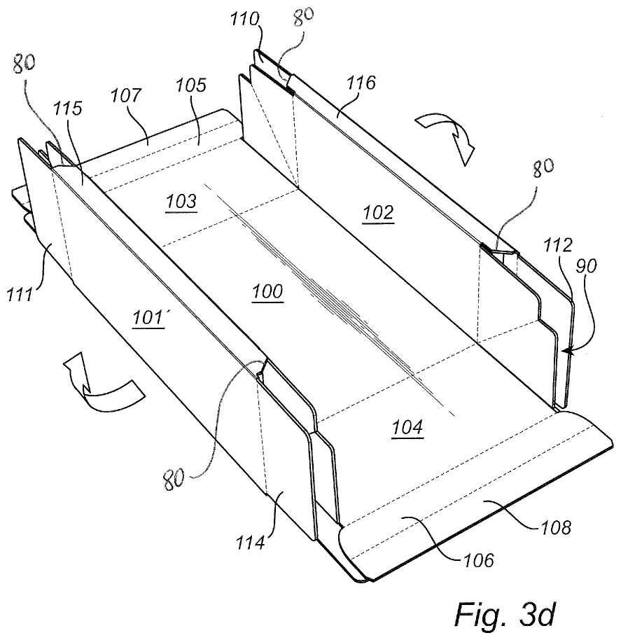

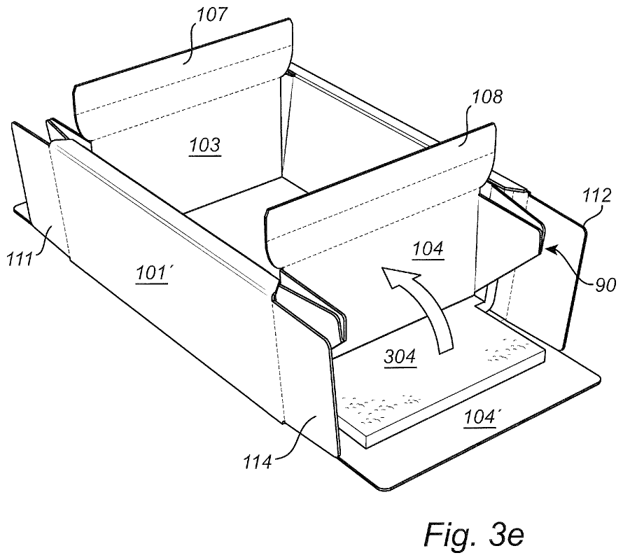

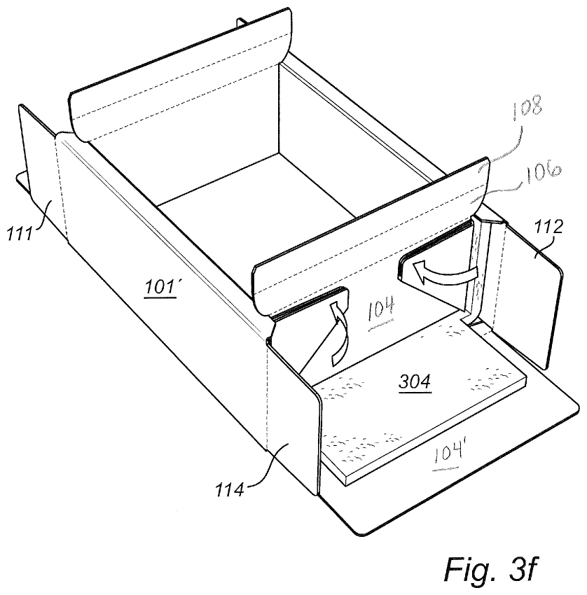

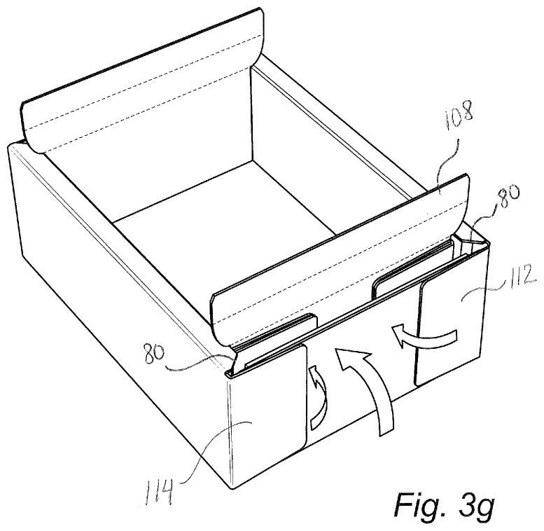

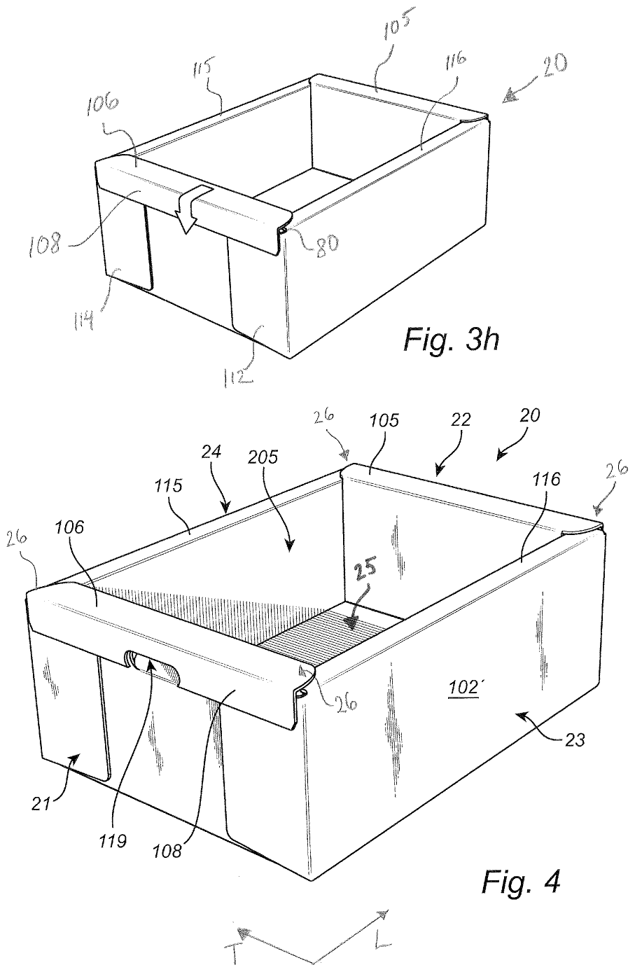

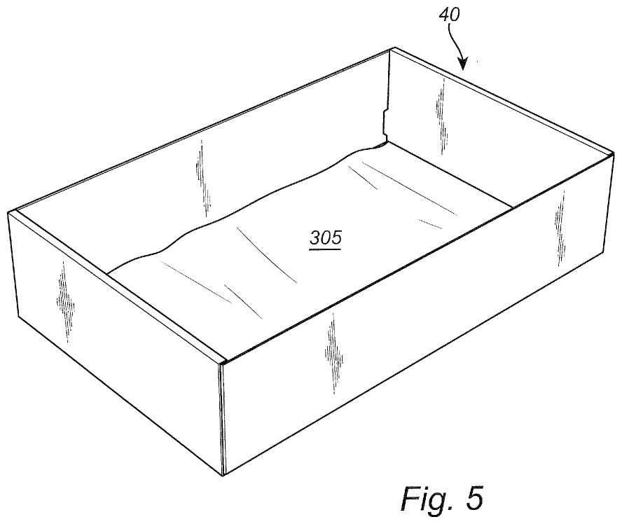

With reference to FIG. 1a, there is disclosed a blank 10 configured to be folded and erected into a double-walled box 20 (the box 20 also being referred to as a package or a container), by being erected in the manner as disclosed in FIGS. 3a-h. FIG. 4 shows a completely erected box 20. FIG. 5 shows a lid 40 arranged to cover a box 20 according to the invention. The longitudinal direction L as well as the transverse direction T are indicated in FIG. 1a.

As illustrated in FIG. 1a, the blank 10 comprises a rectangular inner bottom panel 100, a first inner side wall panel 101 and a second inner side wall panel 102 being foldably connected to a respective one of two opposing longitudinally extending sides 131; 132 of the inner bottom panel 100. The blank 10 further comprises a first inner end wall panel 103 and a second inner end wall panel 104 being foldably connected to a respective one of two opposing transversally extending sides 123; 124 of the inner bottom panel 100. The inner bottom panel 100 constitutes the interior/inner bottom of an erected box 20. The interior bottom of the box 20 is the part typically being horizontally positioned when the box is resting on the ground.

The blank 10 further comprises a rectangular outer bottom panel 100′ arranged to be aligned with the inner bottom panel 100 when the blank 10 is folded into a box 20. The rectangular outer bottom panel 100′ is larger in size compared to the inner bottom panel 100. This means that the longitudinal sides 141; 142 as well as the transversal sides 125; 126 of the outer bottom panel 100′ are longer than the longitudinal sides 131; 132 and the transversal sides 123; 124 of the inner bottom panel 100. The outer bottom panel 100′ constitutes the outer bottom of an erected box 20, typically being horizontally positioned when such a box is resting on the ground in an upright position.

Furthermore, the blank 10 comprises a first outer side wall panel 101′ comprising two opposing longitudinally extending sides 117; 118 wherein said first longitudinally extending side 117 is facing said first inner side wall panel 101 and said second longitudinally extending side 118 is foldably connected to said outer bottom panel 100′, meaning that the first outer side wall panel 101′ is sandwiched between the first inner side wall panel 101 and the outer bottom panel 100′. The blank 10 further comprises a second outer side wall panel 102′ which is facing said second inner side wall panel 102.

The inner bottom panel 100, the first and second inner side wall panels 101; 102 and the first and second inner end wall panels 103; 104 together define a box interior 205 (seen in FIG. 4) when the blank 10 is formed into a box 20. Moreover, the outer bottom panel 100′, the first and second outer side wall panels 101′; 102′, and the first and second outer end wall panels 103′; 104′ are in their turn configured to form an outermost layer of such a box 20. The single piece blank 10 according to FIG. 1a can thus be folded into a box 20 where each side (side walls and bottom portion respectively) comprises double walls, i.e. a double-walled box 20. In a preferred embodiment, said double walls are forming inner spaces, i.e. inner cavities, inside each of the side walls and the bottom of the erected box. As a result, the side wall panels and the bottom panels respectively are separated from each other by the inner spaces, so that they do not abut one another. Such inner cavities may be filled with insulating material or they may be empty.

The blank 10 further comprises transversal extension panels 105; 106 arranged between said respective inner end wall panel 103; 104 and said respective gluing panel 107; 108, i.e. the transversal extension panels are sandwiched therebetween. In a corresponding manner, the blank 10 also comprises longitudinal extension panels 115; 116 arranged between said respective inner side wall panel 101; 102 and said respective outer side wall panel 101′; 102′. As seen in FIG. 4, said transversal and longitudinal extension panels will form upper, horizontal surfaces of an erected box 20 and be useful e.g. as stacking planes. Moreover, as realised from looking at e.g. FIGS. 3-4, the width and length of said transversal extension panels 105; 106; 115; 116 will also define the width and length of said inner cavities 201; 202; 203; 204 (to be described later).

Referring again to FIG. 1a, it is seen that the longitudinal sides 137; 138 of the inner side wall panels 101; 102 are shorter than the longitudinal sides 117; 121 of the outer side wall panels 101′; 102′. This contributes to creating the inner cavities arranged to receive insulating layers. One way of achieving this difference in length is that the outermost, short-sides of each of said longitudinal extension panels 115; 116 have oblique edges 80. This is better seen in the close-up of FIG. 1b. Herein, the oblique edge 80 extend obliquely from the distal corner section 81 of the respective inner side wall panel 101 to a meeting corner section 82 of the respective outer side wall panel 101′. As also seen in FIG. 1b, the transversal folding line 133 of the inner side wall panel 101 is parallel, but not aligned, with the transversal folding line 135 of the outer side wall panel 101′. The oblique side 80 of the longitudinal extension panel 115 forms a connection between the parallel transversal folding lines 133; 135 of the inner and outer side wall panels 101; 101′.

The box 20 of the invention is leakproof, meaning that it may transport wet and moist content while preventing leakage out of the box interior 205. In accordance herewith, the panels which are arranged to define the box interior 205 comprise a specific design seen in FIG. 1, wherein at each corner of the inner bottom panel 100, the respective inner side wall panels 101; 102 is interconnected with the inner end wall panels 103; 104 via a respective set of corner panels 91; 92 together forming a corner section 90. The corner panels 91, 92 are foldable relative to the respective inner side wall panel 101; 102, to the respective inner end wall panel 103; 104, as well as to each other about an internal fold line FL90 into triangular flaps, as the blank 10 is formed into said box 20. This configuration leads to that no raw edges are present in the receiving compartment which constitutes the inside 205 of an erected box 20. In other words, the interior/inner surface below a horizontal top plane of an erected box 20 is free from raw edges/slots/openings, meaning that the cardboard material is not punctuated below that plane resulting in a leakproof structure. In combination with a moisture and water-resistant coating or treatment of the blank material, such as a polymer-based inner lining, the box 20 provides a reliable way to transport and carry wet products, such as wet food products, including e.g. meat, vegetables or fish.

The box 20 according to the invention may further be thermally insulated by means of being equipped with at least one thermally insulating layer or material. As previously described, the erected box 20 comprises double-walled side walls as well as a double-walled bottom. Said side walls and said bottom each define a respective inner cavity 200; 201; 202; 203; 204. This is seen for example in FIG. 3c. Preferably, each of said inner cavities is arranged to receive an insulating layer or insulating material. One example is insulation panel members. In accordance herewith, the box 20 may be arranged with insulating layers inserted between the double walls. One example of an insulating panel layer assembly 30 is shown in FIG. 2 which discloses a set of foldably interconnected insulation panels 300; 301; 302. The example in FIG. 2 shows panels made from recyclable corrugated board material. Other types of insulating layers are conceivable, such as separate insulation panels to be glued onto the blank upon assembly to a box 20, and/or different types of material such as paper or foamed cellulose.

In a one aspect, the insulating layer/s are integrated into the box 20 simultaneous to the folding and erecting procedure, i.e., the insulation panels 300; 301; 302 are put into place on the blank 10 and folded together with the blank during the forming of the box 20 according to the invention.

Preferably, the insulating material is a fiber-based material capable of being recycled or is substantially biodegradable or compostable or any combination thereof.

Another example of suitable insulating material is loose material or loose cellulose-based material that can be injected into the cavities of an erected box according to the invention. For instance so-called clippings may be fiberized into a loose cellulose-based material suitable for insulation purposes. Clippings in its turn can be obtained from shredding recycled cardboard or paper whereafter they (i.e. the clippings) are fiberizing into small clusters that can be inserted into a cavity of the package. The loose cellulose mass or loose cellulose material can be made from other sources than recycled fibers or pulp, such as from virgin pulp, fiberized corrugated cardboard waste, fiberized wood, textile fiber, polymer-based foam, wood foam and/or mineral-based granulate (vermiculite, perlite).

If using loose, injectable material for insulation according to the invention, the box 20 is firstly erected whereafter openings are created to access the empty inner cavities. The loose insulation material is then injected via said openings into the cavities of the box 20. One way of injecting the material is by blowing, such as injection blowing including pneumatic injection technology. After that the cavities have been filled with insulation material, the openings are suitably sealed off, e.g. with stickers.

An example of assembly of a thermally insulated box 20 from a cut out blank 10 according to the invention will now be described, referring mainly to FIGS. 3a-h. Herein, assembly is performed with insulation panels, however as understood from the previous description, the insulation panels are optional, i.e. the cavities may be left empty or insulation panels may be inserted at later folding steps, or for that matter-other types of insulation can be used such as loose, injectable material.

The resulting box is seen in FIG. 4. In FIG. 4 there is also indicated the longitudinal direction L and the transversal direction T of the box 20. See also corresponding “L” and “T” in FIG. 1a. In line herewith, it is understood that by “longitudinally” means having an extension at least substantially along a longitudinal extension of the box 20, and “transversally” means having an extension at least substantially along a transversal extension of the box 20.

A blank 10 as seen in FIG. 1 is provided and placed such that a first major surface 10a is facing downwards (i.e., facing the ground), thus exposing a second major surface 10b. The first major surface 10a corresponds to the side of the blank 10 which partially forms the inside 205 of an erected box 20. An insulating layer assembly 30 is provided and positioned on top of the second major surface 10b of said blank 10. In FIG. 3a, this is shown in that the foldably interconnected insulation panels 300; 301; 302 seen in FIG. 2 are placed so that an insulation bottom panel 300 is positioned on the inner bottom panel 100, and insulation side panels 301; 302 are positioned on top of the corresponding first and second inner side wall panels 101; 102. The insulation panels 30 may be adhesively attached to the blank 10. Optionally, the insulation panels 30 may be placed on the blank 10 without adhesive connection. FIG. 3a shows that the first and inner side wall panels 101; 102 of the blank 10 and the abutting insulation panels 301; 302 are folded downwards with respect to the inner bottom panel 100 and the abutting bottom insulation panel 300. Next, as seen in FIG. 3b, the first and second outer side wall panels 101′; 102′ are folded upwardly so that the insulation side panels 301; 302 are enclosed in the cavities formed between the inner and outer wall panels. As is seen in FIG. 3b, a longitudinally extending gluing panel 109 is foldably connected to a longitudinal side 120 of said second outer side wall panel 102′. This gluing panel 9 is folded over the insulation bottom panel 300 present on top of the inner bottom panel 100 into flat abutment therewith. The outer bottom panel 100′ is then folded over the insulation bottom panel 300 as seen in FIGS. 3b and 3c, to overlap and abut the gluing panel 9 at the opposite side of the inner bottom panel and is adhesively connected to said gluing panel 9. The surface of the outer bottom panel 100′ displayed in FIG. 3c represents the outer bottom of the soon-to-be box 20, i.e., the part of the box which will be in contact with the ground as the box 20 is in transport mode as seen in FIG. 4.

To illustrate the continuous folding procedure, the semi-formed box is turned around as shown in FIG. 3d, so that the outer bottom 101′ of the box is in contact with the ground. The short end walls of the box are now to be closed. Turning to FIG. 3e, one of the inner end wall panels 104 is folded upwardly whereby said triangular flaps 91; 92 formed at the corners 90 are folded outwardly in a direction away from the inner bottom panel 100, and then, as in FIG. 3f, into abutment with an outwardly facing surface of the respective inner end wall panel 104.

In FIG. 3f there is seen yet another insulation panel 304 positioned on top of the corresponding outer end wall panel 104′. The outer end wall panel 104′ is folded along with the insulation panel 304 to align with the inner end wall 104. A pair of gluing flaps 112; 114 are foldably connected to a respective one of two opposing transversally extending short sides of said outer side wall panels 101′; 102′. In FIG. 3g it is seen that said gluing flaps 112; 114 are folded to abut the outer layer of said outer end wall panel 104′ and are adhesively connected thereto. As a final step in forming the box 20, a transversally extending gluing panel 108, which is foldably connected to the extension panel 106 is brought to cover the cavity opening as seen in FIG. 3h, and is adhesively connected to the outer surface of said gluing flaps 112; 114. As also seen in FIG. 3h, the oblique edges 80 of the longitudinal extension panels 115; 116 are covered by the transversal extension panels 105; 106 to efficiently seal off the inner cavities of the box 20.

The double-walled box 20 formed by erecting the blank 10 is shown in transportation mode in FIG. 4. Herein, the box 20 is positioned in a neutral state with the bottom resting on the ground, presenting the receiving compartment which constitutes the inside/interior 205 of the box 20. The box comprises a first and second short side 21; 22 and a first and second long side 23, 24. The box also comprises a bottom 25. Each side 21; 22; 23; 24 as well as said bottom 25 is configured to have double walls as previously described. In one aspect of the present box 20, inner cavities 200; 201; 202; 203; 204 are formed between each of the double walls. In one aspect of the invention, said cavities are arranged to receive insulation layers 30, such as insulating panels 300; 301; 302; 303; 304, for thermally insulating the interior space 205 of the box 20. Other insulating material can also be used such as the above-described loose blow-injectable material. In accordance herewith, the box 20 preferably comprises inner insulation material which is completely shielded from the exterior by said double walls. The efficient shielding of the cavities from the outside is for instance accomplished by means of the design of the upper corners 26 of the box. As seen in FIG. 4, and as also understood from the previous description, the sealing of the cavities is for instance achieved in that the end portions 80 of the longitudinal extension panels 115; 116 are covered by the corresponding end portions of the transversal extension panels 105; 106.

The skilled person understands that a box 20 with empty inner cavities, i.e. lacking insulating material, is also part of the present invention.

In one embodiment, the box 20 has a longitudinal length between 400-800 mm and a transversal width between 300-400 mm. Examples of box dimensions include bottom measures of 400×300 or 600×400 or 800×400 mm respectively, given in outer bottom dimensions lengthxwidth.

In the example of FIG. 4, the disclosed box 20 is provided with a cut-out 119 located in the transversally extending gluing panel 108, said cut-out being configured to form a handle.

In the example of FIG. 4, it is seen that the horizontally positioned extension panels 105; 106; 115; 116 form top planar surfaces which may serve as stacking plane for the box 20.

In order to protect the content of a box 20 a lift-off lid 40 is provided as seen in FIG. 5. Said lid 40 is configured to seal the box interior 205 from the surroundings by covering the top portion of the box 20. The lid may or may not comprise an inner insulating panel 305. An insulating panel can for instance be adhered to the inner surface as illustrated in FIG. 5.

Even though it is preferred that the blank and package are designed in accordance with the disclosure in the detailed disclosure of preferred embodiments and the appended drawings, it should be noted that a specific preferred embodiment of a specific component does not necessarily have to be combined with a specific embodiment of another component. Thus, advantages associated with a specific embodiment, including one or more features, of a specific component may be accomplished even though the other component s is/are designed in accordance with the more general disclosure under the summary of the invention rather than being defined in accordance with the specific embodiment disclosed in the detailed description.

It is contemplated that there are numerous modifications of the embodiments described herein, which are still within the scope of the invention as defined by the appended claims. Additionally, the mere fact that certain measures are recited in mutually different dependent claims does not indicate that a combination of these measured cannot be used to advantage.

1. A blank for forming a double-walled box, the blank comprising:
a rectangular inner bottom panel,
a first inner end wall panel and a second inner end wall panel foldably connected to a respective one of two opposing transversally extending sides of the rectangular inner bottom panel
a first inner side wall panel and a second inner side wall panel foldably connected to a respective one of two opposing longitudinally extending sides of the rectangular inner bottom panel,
a rectangular outer bottom panel which is larger in size than said rectangular inner bottom panel,
a first outer end wall panel and a second outer end wall panel being foldably connected to a respective one of two opposing transversally extending sides of the outer bottom panel,
a first outer side wall panel comprising two opposing longitudinally extending sides, where a first longitudinally extending side is foldably connected to said first inner side wall panel and a second longitudinally extending side is foldably connected to said rectangular outer bottom panel, and,
a second outer side wall panel being foldably connected to a longitudinally extending side of said second inner side wall panel,
wherein the rectangular inner bottom panel, the first inner side wall panel, the second inner side wall panel, the inner end wall panel, and the second inner end wall panels defines a box interior when the blank is formed into a box, and
wherein the rectangular outer bottom panel, the first outer side wall panel, the second outer side wall panels, the first outer end wall panel, and the second outer end wall panels are configured to form an outer layer of said box when the blank is formed into the box, such that each side of the box comprises double walls.

2. The blank according to claim 1, wherein said double walls formed at each side of a box define an inner cavity arranged to receive an insulating layer.

3. The blank according to claim 2, wherein at each corner of the inner bottom panel, the respective inner side wall panels is interconnected with the inner end wall panels by a respective set of corner panels together forming a corner section, the corner panels of the respective set configured to fold relative to the respective inner side wall panel, to the respective inner end wall panel and to each other about an internal fold line into triangular flaps, as the blank is formed into said box.

4. The blank according to claim 3, wherein the triangular flaps are configured to fold outwardly, in a direction away from the rectangular inner bottom panel.

5. The blank according to claim 1, further comprising:
gluing flaps foldably connected to a respective one of two opposing transversally extending short sides of said outer side wall panels, wherein the gluing flaps are configured to be adhesively connected to an outer layer of said outer end wall panels as the blank is formed into said box.

6. The blank according to claim 1, further comprising:
a set of transversally extending gluing panels foldably connected to opposite transversally extending short sides of said inner end wall panels.

7. The blank according to claim 1, further comprising:
a longitudinally extending gluing panel foldably connected to a longitudinal side of said second outer side wall panel.

8. The blank according to claim 6, further comprising:
a transversal extension panel arranged between each inner end wall panel and saida-transversally extending gluing panel

9. The blank according to claim 7, further comprising:
a longitudinal extension panels arranged between each inner side wall panel and an outer side wall panel.

10. The blank according to claim 9, wherein longitudinal sides of the inner side wall panels are shorter than the longitudinal sides of the outer side wall panels.

11. The blank according to claim 10, wherein outermost distal short-sides of each respective longitudinal extension panel are arranged with oblique edges extending obliquely from corner sections of a respective inner side wall panel, to a meeting corner section of a respective outer side wall panel resulting in that the longitudinal sides of the inner side wall panels are shorter than the longitudinal sides of the outer side wall panels.

12. The blank according to claim 1, wherein the black comprises a corrugated fiberboard material.

13. The blank according to claim 1, further comprising:
a moisture and water-resistant coating or treatment to provide water resistance for packaging and transporting in wet or damp environment.

14. A box formed from the blank of claim 1, wherein the box comprises a double-walled box.

15. A thermally insulated box formed from the blank of claim 2, wherein the thermally insulated box comprises a double-walled box with at least one thermally insulating layer inside at least one of said inner cavities.

16. The thermally insulated box according to claim 15, wherein said at least one thermally insulating layer comprises a recyclable material including cellulose-based material.

17. The thermally insulated box according to claim 16, wherein said at least one thermally insulating layer comprises cardboard or paper.

18. The thermally insulated box according to claim 16, wherein said at least one thermally insulating layer comprises foamed cellulose material.
